(19) United States
(12) Patent Application Publication
(10) Pub. No.: US 2025/0356606 A1
(43) Pub. Date: Nov. 20, 2025

(54) INTERACTION METHOD, APPARATUS AND DEVICE, AND STORAGE MEDIUM

(71) Applicants: Lemon Inc., Grand Cayman (KY); Beijing Zitiao Network Technology Co., Ltd., Haidian District (CN)

(72) Inventors: Zichun Wang, Culver City, CA (US); Yue Chen, Beijing (CN); Kin Chung Wong, Los Angeles, CA (US); Hao Qiu, Beijing (CN); Siyuan Chen, Culver City, CA (US); Jonathan Guzi, Culver City, CA (US); You Xie, Los Angeles, CA (US); Linjie Luo, Los Angeles, CA (US)

(21) Appl. No.: 19/215,034

(22) Filed: May 21, 2025

Related U.S. Application Data
(63) Continuation of application No. PCT/CN2024/094314, filed on May 20, 2024.

(51) Int. Cl. G06T 19/20; G06T 13/40

(52) U.S. Cl. CPC G06T 19/20; G06T 13/40; G06T 2219/2012; G06T 2219/2024

(57) ABSTRACT

Embodiments of the disclosure relate to an interaction method, device and apparatus, and a storage medium. The method provided herein includes: displaying a setting interface for a user, the setting interface displaying a set of static representations corresponding to a set of avatars in a first region, the set of avatars being generated based on obtained image of the user; based on a selection of a target static representation in the set of static representations, displaying a target dynamic representation corresponding to the target static representation in a second region of a setting interface, wherein the target static representation and the target dynamic representation are associated with a target avatar; and associating the target avatar to the user.

### CROSS-REFERENCE

The present application claims priority to PCT Application No. PCT/CN2024/094314, filed on May 20, 2024, and entitled “INTERACTION METHOD, APPARATUS AND DEVICE, AND STORAGE MEDIUM”, the entirety of which is incorporated herein by reference.

### FIELD

Example embodiments of the present disclosure generally relate to the field of computers, and in particular, to an interaction method, apparatus, device, and computer-readable storage medium.

### BACKGROUND

In recent years, with the development of the Internet, when a user performs a network activity on a plurality of application platforms, the setting and display of an avatar becomes an important way of personal expression. The user presents the individual style or information desired to be conveyed by setting up an avatar or other avatar.

### SUMMARY

In a first aspect of the present disclosure, an interaction method is provided. The method comprises: displaying a setting interface for a user, wherein the setting interface displays a set of static representations corresponding to a set of avatars in a first region, and the set of avatars are generated based on obtained image of the user; based on a selection of a target static representation in the set of static representations, displaying a target dynamic representation corresponding to the target static representation in a second region of a setting interface, wherein the target static representation and the target dynamic representation are associated with a target avatar; and associating the target avatar to the user.

In a second aspect of the present disclosure, an apparatus for interaction is provided. The apparatus comprises: a first presenting module configured to display a setting interface for a user, wherein the setting interface displays a set of static representations corresponding to a set of avatars in a first region, and the set of avatars are generated based on obtained image of the user; a second presenting module configured to, based on a selection of a target static representation in the set of static representations, display a target dynamic representation corresponding to the target static representation in a second region of the setting interface, the target static representation and the target dynamic representation being associated with a target avatar; and an associating module configured to associate the target avatar to the user.

In a third aspect of the present disclosure, there is provided an electronic device, the device comprising at least one processor; and at least one memory coupled to the at least one processor and storing instructions for execution by the at least one processor. The instructions, when executed by the at least one processor, cause the apparatus to perform the method of the first aspect.

In a fourth aspect of the present disclosure, a computer readable storage medium is provided, where the computer readable storage medium stores a computer program, and the computer program is executable by a processor to implement the method in the first aspect.

It should be appreciated that what is described in this Summary is not intended to limit critical features or essential features of embodiments of the disclosure, nor is it intended to limit the scope of the disclosure. Other features of the present disclosure will become readily appreciated from the following description.

### BRIEF DESCRIPTION OF THE DRAWINGS

The above and other features, advantages, and aspects of various embodiments of the present disclosure will become more apparent with reference to the following detailed description taken in conjunction with the accompanying drawings. In the drawings, the same or similar drawing reference numerals denote the same or similar elements, wherein:

FIG. 1 illustrates a schematic diagram of an example environment capable of implementing some embodiments of the present disclosure;

FIGS. 2A to 2E illustrate example interfaces according to some embodiments of the present disclosure;

FIG. 3 illustrates a flowchart of an example process of interaction, according to some embodiments of the disclosure;

FIG. 4 illustrates a schematic structural block diagram of an example apparatus for interaction, according to some embodiments of the disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. Although certain embodiments of the present disclosure are shown in the accompanying drawings, it should be understood that the present disclosure may be implemented in various forms and should not be construed as limited to the embodiments set forth herein, but rather, these embodiments are provided for a thorough and complete understanding of the present disclosure. It should be understood that the drawings and embodiments of the present disclosure are only for illustrative purposes and are not intended to limit the scope of the present disclosure.

It should be noted that the headings of any section/subsection provided herein are not limiting. Various embodiments are described throughout herein, and any type of embodiment can be comprised under any section/subsection. Furthermore, embodiments described in any section/subsection may be combined in any manner with any other embodiments described in the same section/subsection and/or different sections/subsections.

In the description of the embodiments of the present disclosure, the term “comprising” and the like should be understood as open-ended comprising, that is, “comprising but not limited to.” The term “based on” should be read as “based at least in part on.” The term “one embodiment” or “the embodiment” should be read as “at least one embodiment.” The term “some embodiments” should be understood as “at least some embodiments.” Other explicit and implicit definitions may also be comprised below. The terms “first”, “second”, etc., may refer to different or identical objects. Other explicit and implicit definitions may also be comprised below.

Embodiments of the present disclosure may relate to data, acquisition and/or use of data, etc., by a user, all following respective legal regulations and related regulations. In embodiments of the present disclosure, all data collection, acquisition, processing, processing, forwarding, use, and the like, are made with user knowledge and confirmation. Accordingly, when implementing the embodiments of the present disclosure, the user should be informed of the types of data or information that may be involved, a usage range, a usage scenario, and the like in an appropriate manner according to relevant legal regulations, and the authorization of the user is obtained. The specific informing and/or authorization manner may vary according to actual situations and application scenarios, and the scope of the present disclosure is not limited in this aspect.

In the present description and the embodiments, the personal information processing is performed on the basis of legitimacy (for example, the consent of the personal information body is obtained, or necessary for fulfillment of a contract, etc.), and is performed only within a predetermined range or a predetermined range. The user rejects personal information other than the necessary information required for processing the basic function, and the use of the basic function by the user is not affected.

As mentioned briefly above, when a user performs a network activity on a network platform, the setting and presentation of an avatar becomes an important way of personal expression. The user may, for example, present a personal style or other information desired to be conveyed by setting up an avatar or other avatar. In addition, when selecting an avatar, a user usually lacks a preview of a dynamic effect, which makes it difficult for the user to predict and confirm a final display effect, thereby affecting the accuracy of setting.

Embodiments of the present disclosure provide a solution for interaction. According to the solution, a setting interface for a user can be displayed, and the setting interface displays a set of static representation corresponding to a set of avatars in a first region, wherein the set of avatars are generated based on obtained image of the user; based on a selection of a target static representation in the set of static representations, displaying a target dynamic representation corresponding to the target static representation in a second region of a setting interface, wherein the target static representation and the target dynamic representation are associated with a target avatar; and associating the target avatar to the user.

In this way, by presenting the dynamic representation corresponding to the avatar to the user, the embodiments of the present disclosure can better help the user to perceive the expressing state corresponding to the corresponding avatar. Thus, the embodiments of the present disclosure can improve the accuracy of avatar setting, thereby improving the interaction experience of the user.

Various example implementations of the solution are described in further detail below with reference to the accompanying drawings.

### Example Environment

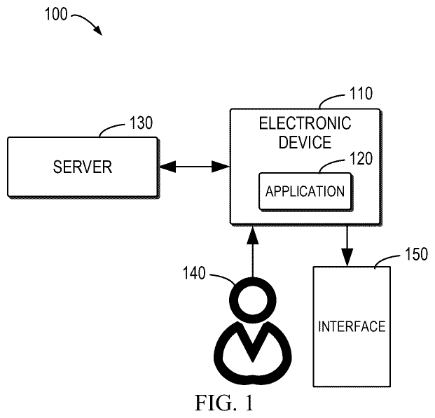

FIG. 1 shows a schematic diagram of an example environment 100 in which embodiments of the present disclosure can be implemented. As shown in FIG. 1, the example environment 100 can comprise an electronic device 110.

In this example environment 100, the electronic device 110 can run an application 120 that supports interface interaction. The application 120 can be any suitable type of application for interface interaction, and examples of which can comprise, but are not limited to, video applications, social applications, or other suitable applications. User 140 may interact with application 120 via electronic device 110 and/or an attached device thereof.

In the environment 100 of FIG. 1, if the application 120 is active, the electronic device 110 may present an interface 150 through the application 120 to support interface interaction.

In some embodiments, electronic device 110 communicates with server 130 to enable the provision of services to application 120. The electronic device 110 may be any type of mobile terminal, fixed terminal, or portable terminal, comprising a mobile phone, a desktop computer, a laptop computer, a notebook computer, a netbook computer, a tablet computer, a media computer, a multimedia tablet, a palmtop computer, a portable game terminal, a VR/AR device, and a Personal Communication System, a PCS) device, personal navigation device, personal digital assistant (PDA), audio/video player, digital camera/camcorder, positioning device, television receiver, radio broadcast receiver, electronic book device, game device, or any combination of the foregoing, comprising accessories and peripherals for these devices, or any combination thereof. In some embodiments, electronic device 110 can also support any type of interface to a user (such as a ‘wearable’ circuit or the like).

The server 130 may be an independent physical server, may also be a server cluster or a distributed system formed by a plurality of physical servers, and may also be a cloud server that provides basic cloud computing services such as cloud services, cloud databases, cloud computing, cloud functions, cloud storage, network services, cloud communications, middleware services, domain name services, security services, content distribution netcontent items, and big data and artificial intelligence platforms. Server 130 may comprise, for example, a computing system/server, such as a mainframe, an edge computing node, a computing device in a cloud environment, etc. The server 130 may provide background services for the virtual scene-enabled application 120 in the electronic device 110.

A communication connection may be established between the server 130 and the electronic device 110. The communication connection may be established in a wired manner or a wireless manner. Communication connections may comprise, but are not limited to, Bluetooth connections, mobile network connections, Universal Serial Bus (USB) connections, Wireless Fidelity (WiFi) connections, and the like, to which embodiments of the present disclosure are not limited. In embodiments of the present disclosure, the server 130 and the electronic device 110 may enable signaling interaction through a communication connection therebetween.

It should be understood that the structure and function of the various elements in environment 100 are described for exemplary purposes only, and are not intended to imply any limitation on the scope of the disclosure.

Some example embodiments of the present disclosure will be described below with continued reference to the accompanying drawings.

### Example Interactions

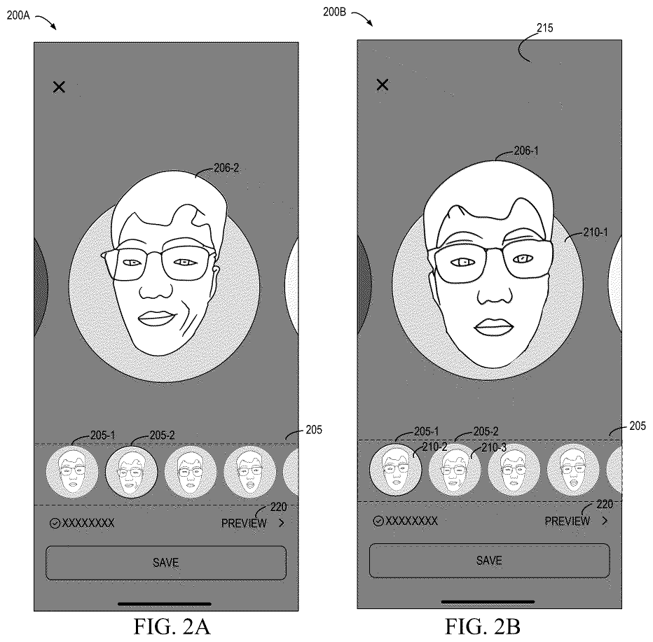

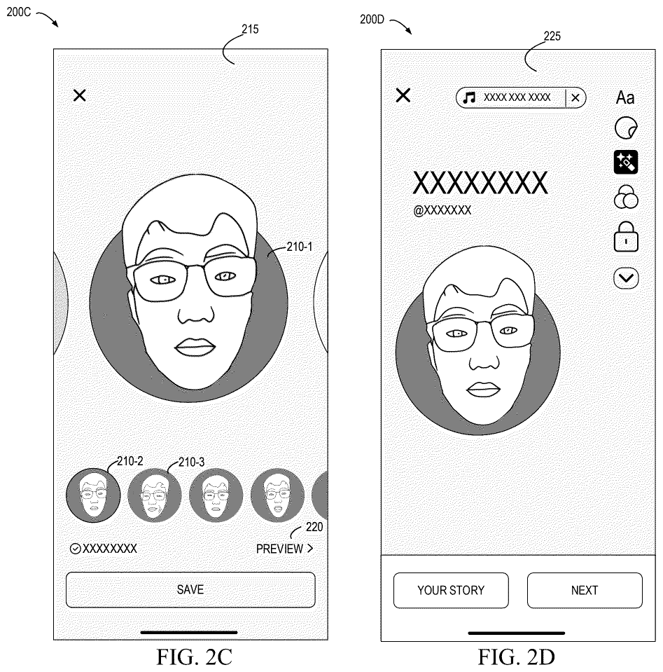

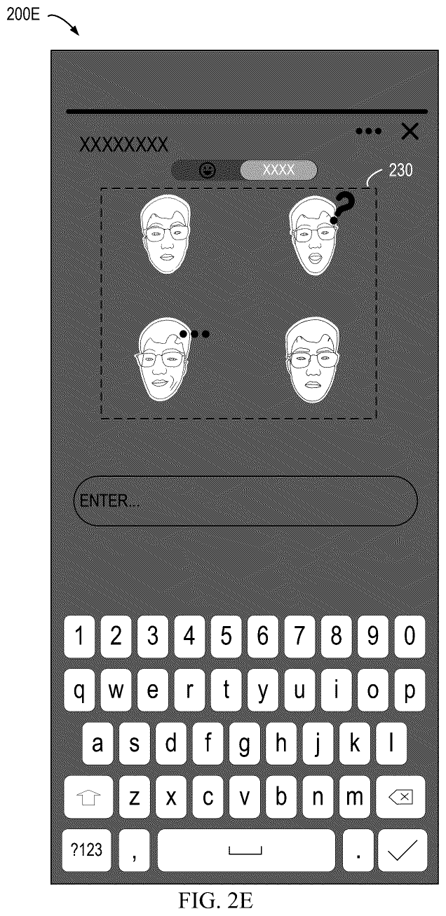

FIGS. 2A to 2E illustrate example interfaces 200A to 200E, according to some embodiments of the disclosure. The interfaces 200A to 200E, for example, may be provided by the electronic device 110 shown in FIG. 1.

In some embodiments, as shown in FIG. 2A, electronic device 110 may display a setting interface 200A for a user. The setting interface 200A displays a set of static representations 205 corresponding to a set of avatars in a first region, the set of avatars being generated based on the obtained image of the user.

In some embodiments, the process of generating a set of avatars may comprise: obtaining, by the server 130, at least one reference image based on an operation (also referred to as a configuration operation) of a user. As an example, the configuration operation may comprise selecting an image from a photo album or taking an image with a camera component. By way of example, the reference image may be an image in a photo album or an image taken by a camera component.

In some embodiments, the process of generating a set of avatars may further comprise: generating, by the server 130, a visual model based on the at least one reference image. In some embodiments, the generated visual model may also be referred to as a digital or virtual avatar of the user.

As an example, the visual model may be a three-dimensional model obtained based on the reference image, and the visual model may be obtained by invoking a preset model to process the at least one reference image. The preset model may be implemented as any model capable of converting a two-dimensional image into a three-dimensional model, and specific details of the preset model is not limited in the present invention.

In some embodiments, the server 130 may also generate a plurality of dynamic image content that correspond to a plurality of actions based on the visual model. That is to say, the server 130 may control the motion of the visual model to generate a plurality of actions. Further, the server 130 may record a plurality of action processes, and generate a plurality of corresponding dynamic image contents according to the action processes. As an example, an action process may comprise multiple image frames, which may be synthesized to be a dynamic image content.

In some embodiments, the process of generating a set of avatars may also comprise: the server 130 constructing a set of avatars based on the plurality of dynamic image contents. As an example, the server 130 may construct the corresponding avatar with all or a truncated portion of the dynamic image content. As an example, the server 130 may also generate the corresponding avatar by adding additional elements (e.g., text, graphics, music, etc.) to the dynamic image content.

In some embodiments, the server 130 may also obtain image corresponding to a set of avatars based on the generated set of avatars. Further, the electronic device 110 may draw a set of avatars in a setting interface (or any other interface that needs to present the avatar) based on the image (corresponding to the set of avatars).

In some embodiments, the set of avatars comprise a plurality of avatars corresponding to a plurality of expressing states of the user. As an example, the user may be determined based on the at least one reference image. As an example, the visual model may be a visual model associated with the user. The plurality of expressing states may be embodied based on the plurality of actions of the above-mentioned visual model.

In some embodiments, such expressing states may correspond to states conveyed by the avatar, e.g., happiness, thought, sadness, etc. Such states may be conveyed, for example, by different actions and/or different facial looks of the visual model.

In some embodiments, the expressing state may comprise an action process and/or a static expression.

In some embodiments, a plurality of dynamic representations of a plurality of avatars may correspond to different action processes of the user (e.g., a process of making a like gesture, a head-shaking action process, etc.). In some embodiments, a plurality of static representations of a plurality of avatars may correspond to different static representations of the user (e.g., a happy facial look, a sad facial look, etc.).

In some embodiments, with continued reference to FIG. 2A, the electronic device 110 may select, based on a selection of a first static representation 205-2 of the set of static representations 205 (e.g., a click operation or a sliding operation for the first static representation, the first static representation 205-2 as a target static representation, and display a first target dynamic representation 206-2 (which may also be referred to as a target dynamic representation) corresponding to the target static representation in a second region of the setting interface 200A.

In some embodiments, as shown in FIG. 2B, the electronic device 100 may determine, based on a selection of a second static representation 205-1 of the set of static representations 205, the second static representation 205-1 as the target dynamic representation, and display in a second region of the setting interface 200A a second target dynamic representation 206-1 (which may also be referred to as a target dynamic representation) that corresponds to the target static representation.

In some embodiments, with continued reference to FIG. 2A, the electronic device 110 may display the target static representations differently in the first region. As an example, as shown in setting interface 200A of FIG. 2A, electronic device 110 may display a first static representation 205-1 (the target static representation) in the form of a bolded outer border to differentiate from other static representations.

In some embodiments, the target static representation and the target dynamic representation are associated with a target avatar. As an example, the target avatar is one of a set of avatars.

In some embodiments, a target dynamic representation (e.g., a dynamic image) may comprise a plurality of image frames, and the target static representation (e.g., a static image) comprise a target image frame determined from a plurality of image frames of the target dynamic representation.

In some embodiments, with continued reference to FIG. 2B, electronic device 110 can present a plurality of target regions 210 in the setting interface 200A, for example, target region 210-1, target region 210-2, target region 210-3, etc. (individually or collectively referred to as target region 210).

In some embodiments, with continued reference to FIG. 2B, the electronic device 110 may present a first background style in a background (which may be referred to as a first background) corresponding to the target region 210.

In some embodiments, with continued reference to FIG. 2B, electronic device 110 may also present a second background 215 (e.g., a background picture of the setting interface 200A) in setting interface 200A. The second background 215 presents a third background style.

In some embodiments, the background style may indicate a background color and/or a background pattern (e.g., regularly arranged shapes, animal picture, etc.) within the corresponding region. As shown in the setting interface 200A in FIG. 2B, the first background style may indicate a background color and/or background pattern (not shown in the figure) within the target region 210. Similarly, the XX background styles mentioned in the present invention may all indicate background colors and/or background patterns in corresponding regions, which will not be repeated hereinafter.

In some embodiments, with continued reference to FIG. 2B, the electronic device 110 may receive a sliding operation associated with the second region. Further, the electronic device 110 may switch, in response to the sliding operation, a first background from a first background style to a second background style, wherein the first background is associated to a target region of at least one of the target static representation or the target dynamic representation.

In some embodiments, with reference to FIG. 2C, electronic device 110 may, in response to a sliding operation, present the setting interface 200C as shown in FIG. 2C. Electronic device 110 may present a second background style in a first background within target region 210 of setting interface 200C.

In some embodiments, with continued reference to FIG. 2C, the electronic device 110 may, in response to the sliding operation, switch the second background 215 of the setting interface 200C from the third background style to the fourth background style.

In some embodiments, with continued reference to FIG. 2C, the target region 210 has a shape corresponding to the persona displaying component. The persona displaying component is configured to display the target static representation or the target dynamic representation with the second background style applied. As an example, the persona displaying component corresponding to the target region 210-1 is configured to display the target dynamic representation with the second background style applied. The persona displaying component corresponding to the target region 210-2 is configured to display the target static representation with the second background style applied.

In some embodiments, with continued reference to FIG. 2C, the electronic device 110 may present an editing interface of a first content item in response to a preview request. By way of example, as shown in the setting interface 200C in FIG. 2C, electronic device 110 may provide a preview component 220. Further, electronic device 110 may present an editing interface of the first content item in response to a trigger to the preview component 220.

In some embodiments, as shown in FIG. 2D, the electronic device 110 presents an editing interface 200D for the first content item. As an example, the first content item may comprise a third background 225 corresponding to a fourth background style. As an example, the first content item may comprise at least one of the target static representation or the target dynamic representation that applies the second background style.

In some embodiments, with continued reference to FIG. 2D, the electronic device 110 may post the first content item in response to a first posting request (e.g., a click operation on a posting-related button) received in the editing interface 200D. By way of example, the first content item may be a video content item or a picture content item, or the like, that is posted in the application 120.

In some embodiments, with continued reference to FIG. 2C, electronic device 110 may, in response to a second posting request received in setting interface 200C, post a second content item associated with the target avatar. As an example, the second content item may be generated and posted based on a preset content item template, and the user is not allowed with an editing operation for the content item.

In some embodiments, the electronic device 110 may associate the target avatar to the user so as to present the target static representation and/or the target dynamic representation on a page associated with the user. As an example, the page associated with the user may be a session page, profile detail page, avatar settings page, etc.

In some embodiments, the electronic device 110 may also obtain reference information associated with the user, and determine, from the plurality of expressing states, a target expressing state that matches the reference information. As an example, the reference information associated with the user may comprise a state that is set in the application 120 by the user, content posted publicly, etc.

In some embodiments, the electronic device 110 may also associate an avatar corresponding to the target expressing state to the user. As an example, electronic device 110 may also associate the avatar corresponding to the target expressing state to the user, comprising: switching the avatar of the user to be the avatar corresponding to the target expressing state.

In some embodiments, the electronic device 110 may determine, based on a type of the page, a style for presenting the avatar on the page from the target static representation and the target dynamic representation. As an example, the electronic device 110 may present, based on that the type of the page is a session page, the target dynamic representation as the style for the avatar on the session page. The electronic device 110 may present, based on that the type of the page is a personal profile detail page, the target static representation as the style of the avatar on the personal profile detail page. It should be noted that, the above determination of the style for the avatar is only an exemplary description herein, and a specific logic for determining the style for the avatar is not limited in the present invention.

In some embodiments, as shown in FIG. 2E, the electronic device 110 may generate a set of materials 230 associated with the target avatar. Further, the electronic device 110 may display a set of materials 230 such that outlines of the set of materials 230 are highlighted (e.g., edges are shown with white outlines). As an example, a set of materials can be used to reply to messages or content items (e.g., articles, graphic content, video content items), etc.

In some embodiments, the electronic device 110 may present a plurality of content items on a content item browsing page. Further, the electronic device 110 may present a set of materials 230 in response to a preset operation (e.g., a click operation) on a target content item among the plurality of content items. Further, the electronic device 110 may send, in response to a trigger (e.g., a click operation) on a target persona material in the set of materials 230, the target persona material to the target content item (e.g., as a comment, or to stick to the surface of the target content item).

Based on the above-described process, the embodiments of the present disclosure can better help the user to perceive the expressing state corresponding to the avatar by displaying the dynamic representation corresponding to the avatar for the user. Thus, the embodiments of the present disclosure can improve the accuracy of avatar setting, thereby improving the interaction experience of a user.

### Example Processes

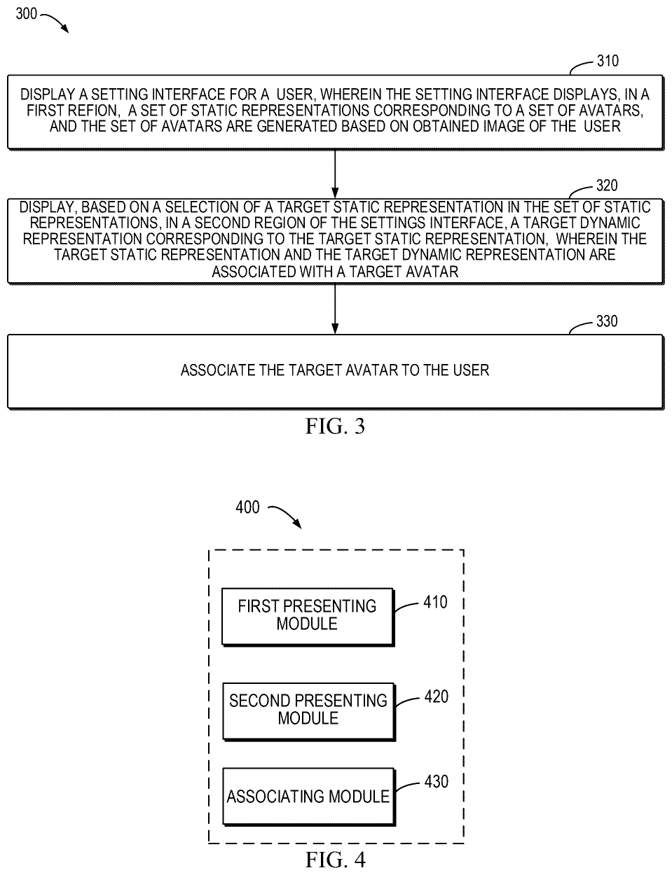

FIG. 3 shows a flowchart of an example process 300 of interaction, in accordance with some embodiments of the present disclosure. Process 300 may be implemented at electronic device 110. Process 300 is described below with reference to FIG. 1.

As shown, in block 310, the electronic device 110 may display a setting interface for a user, the setting interface displaying a set of static representations corresponding to a set of avatars in a first region, the set of avatars being generated based on obtained image of the user.

At block 320, electronic device 110 displays, in a second region of the setting interface, a target dynamic representation corresponding to the target static representation based on a selection of the target static representation in the set of static representations, the target static representation and the target dynamic representation being associated with the target avatar.

In block 330, electronic device 110 associates the target avatar to the user.

In some embodiments, the method 300 further comprises: presenting at least one of the target static representation or the target dynamic representation on a page associated with the user.

In some embodiments, the method 300 further comprises: receiving a sliding operation associated with the second region; and in response to the sliding operation, switching a first background from a first background style to a second background style, wherein the first background is associated to a target region of at least one of the target static representation or the target dynamic representation.

In some embodiments, the first background style or the second background style indicates at least one of a background color or a background pattern displayed within the target region.

In some embodiments, the target region has a shape corresponding to a component of the target avatar, and the component is configured to display at least one of the static representation or the dynamic representation of the target with the second background style applied.

In some embodiments, the method 300 further comprises: in response to the sliding operation, switching a second background of the setting interface from a third background style to a fourth background style; in response to a preview request, presenting an editing interface of a first content item, the first content item comprising: a third background corresponding to a fourth background style, and at least one of the target static representation or a target dynamic representation with the second background style applied; and posting the first content item in response to a first posting request received in the editing interface.

In some embodiments, the method 300 further comprises posting a second content item associated with the target avatar in response to receiving a second posting request in the setting interface.

In some embodiments, the target static representation comprises a target image frame from a plurality of image frames of the target dynamic representation.

In some embodiments, a set of avatars are generated through: obtaining at least one reference image based on an operation of a user; acquiring a visual model based on at least one reference image; generating a plurality of dynamic image contents corresponding to a plurality of actions based on the visual model; and constructing a set of avatars based on the plurality of dynamic image contents.

In some embodiments, the persona data is generated based on the constructed set of avatars.

In some embodiments, the set of avatars comprise a plurality of avatars corresponding to a plurality of expressing states of the user.

In some embodiments, the expressing state comprises at least one of an action process or a static expression, and wherein: a plurality of dynamic representations of the plurality of avatars correspond to different action processes of the user; and/or a plurality of static representations of the plurality of avatars correspond to different static representations of the user.

In some embodiments, method 300 further comprises: obtaining reference information associated with a user; determining, from the plurality of expressing states, a target expressing state that matches the reference information; and associating the avatar corresponding to the target expressing state to the user.

In some embodiments, the method 300 further comprises determining, based on the type of the page, a style for the avatar presented at the page from the target static representation and the target dynamic representation.

In some embodiments, method 300 further comprises: generating a set of materials associated with the set of avatars; and displaying the set of materials with a highlighted outline.

### Example Apparatus and Devices

Embodiments of the present disclosure also provide corresponding means for implementing methods or processes described above. FIG. 4 illustrates a schematic structural block diagram of an example apparatus 400 for interaction, in accordance with certain embodiments of the present disclosure. The apparatus 400 may be implemented as or comprised in an electronic device. The various modules/components in the apparatus 400 may be implemented by hardware, software, firmware, or any combination thereof.

As shown in FIG. 4, the apparatus 400 comprises a first presenting module 410 configured to display a setting interface for a user, wherein the setting interface displays a set of static representations corresponding to a set of avatars in a first region, and the set of avatars are generated based on obtained image of the user; a second presenting module 420 configured to, based on a selection of a target static representation in the set of static representations, display a target dynamic representation corresponding to the target static representation in a second region of the setting interface, the target static representation and the target dynamic representation being associated with a target avatar; and a associating module 430 configured to associate the target avatar to the user.

In some embodiments, the associating module 430 is further configured to: present at least one of the target static representation or the target dynamic representation on a page associated with the user.

In some embodiments, the second presenting module 420 is further configured to: receive a sliding operation associated with the second region; and in response to the sliding operation, switching a first background from a first background style to a second background style, wherein the first background is associated to a target region of at least one of the target static representation or the target dynamic representation.

In some embodiments, the second presenting module 420 is further configured such that the first background style or the second background style indicates at least one of a background color or a background pattern displayed within the target region.

In some embodiments, the second presenting module 420 is further configured to cause the target region to have a shape corresponding to a component of the target avatar, and the component is configured to display at least one of the target static representation or the target dynamic representation with the second background style applied.

In some embodiments, the second presenting module 420 is further configured to: in response to a sliding operation, switch a second background of the setting interface from a third background style to a fourth background style; in response to a preview request, presenting an editing interface of a first content item, the first content item comprising: a third background corresponding to a fourth background style, and at least one of the target static representation or a target dynamic representation with the second background style applied; and posting the first content item in response to a first posting request received in the editing interface.

In some embodiments, the associating module 430 is further configured to post a second content item associated with the target avatar in response to a received second posting request in the setting interface.

In some embodiments, the second rendering module 420 is further configured such that the target static representation comprises a target image frame from the plurality of image frames of the target dynamic representation.

In some embodiments, the apparatus 400 further comprises a generation module configured to: generate a set of avatars through: obtaining at least one reference image based on an operation of a user; acquiring a visual model based on the at least one reference image; generating a plurality of dynamic image contents corresponding to a plurality of actions based on the visual model; and constructing a set of avatars based on the plurality of dynamic image contents.

In some embodiments, the generation module is further configured to generate the persona data based on the constructed set of avatars.

In some embodiments, the generation module is further configured such that the set of avatars comprise a plurality of avatars corresponding to a plurality of expressing states of the user.

In some embodiments, the first presenting module 410 is further configured such that the expressing state comprises at least one of an action process or a static expression, and wherein: a plurality of dynamic representations of a plurality of avatars correspond to different action processes of the user; and/or the plurality of static representations of the plurality of avatars correspond to different static representations of the user.

In some embodiments, the associating module 430 is further configured to: obtain reference information associated with the user; determining a target expressing state, from the plurality of expressing states, that matches the reference information; and associating an avatar corresponding to the target expressing state to the user.

In some embodiments, the associating module 430 is further configured to determine a style for the avatar presented at the page from the target static representation and the target dynamic representation based on a type of the page.

In some embodiments, the generation module is further configured to: generate a set of materials associated with a set of avatars; and displaying the set of materials with a highlighted outline.

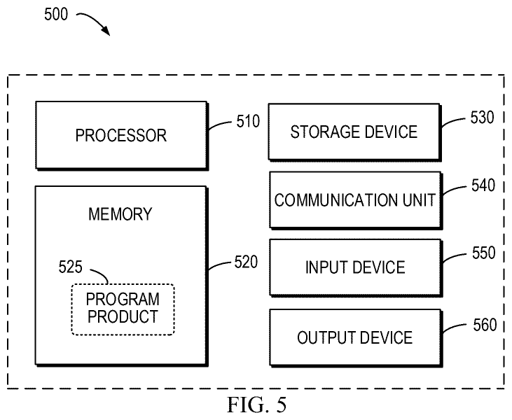

FIG. 5 illustrates a block diagram of an electronic device 500 in which one or more embodiments of the present disclosure may be implemented. It should be appreciated that the electronic device 500 shown in FIG. 5 is merely exemplary and should not constitute any limitation on the functionality and scope of the embodiments described herein. The electronic device 500 shown in FIG. 5 can be used in an electronic device.

As shown in FIG. 5, the electronic device 500 is in the form of a generic electronic device. The components of the electronic device 500 may comprise, but are not limited to, one or more processing units or processors 510, memory 520, storage device 530, one or more communication units 540, one or more input devices 550, and one or more output devices 560. The processor 510 may be a real or virtual processor and may be capable of performing various processes according to programs stored in the memory 520. In a multiprocessor system, a plurality of processors execute computer executable instructions in parallel to improve the parallel processing capability of the electronic device 500.

The electronic device 500 typically comprises a plurality of computer storage media. Such media may be any available media that is accessible to the electronic device 500, comprising, but not limited to, volatile and non-volatile media, removable and non-removable media. Memory 520 may be volatile memory (e.g., registers, cache, random access memory (RAM)), non-volatile memory (e.g., read-only memory (ROM), electrically erasable programmable read-only memory (EEPROM), flash memory), or some combination thereof. Storage device 530 may be a removable or non-removable medium and may comprise a machine-readable medium such as a flash drive, a magnetic disk, or any other medium that may be used to store information and/or data and that may be accessed within electronic device 500.

The electronic device 500 may further comprise additional removable/non-removable, volatile/nonvolatile storage media. Although not shown in FIG. 5, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. Memory 520 may comprise a computer program product 525 having one or more program modules configured to perform various methods or actions of various embodiments of the present disclosure.

The communication unit 540 implements communication with other electronic devices through a communication medium. In addition, functions of components of the electronic device 500 may be implemented by a single computing cluster or a plurality of computing machines, and these computing machines can communicate through a communication connection. Accordingly, the electronic device 500 may operate in a networked environment using logical connections to one or more other servers, network personal computers (PCs), or another network node.

Input device 550 may be one or more input devices such as a mouse, keyboard, trackball, etc. Output device 560 may be one or more output devices such as a display, speakers, printer, etc. The electronic device 500 may also communicate with one or more external devices (not shown), such as storage devices, display devices, etc., as needed through the communication unit 540, with one or more devices that enable a user to interact with the electronic device 500, or with any device (e.g., network card, modem, etc.) that enables the electronic device 500 to communicate with one or more other electronic devices. Such communication may be performed via an input/output (I/O) interface (not shown).

According to an exemplary implementation of the present disclosure, a computer-readable storage medium is provided, on which a computer-executable instruction is stored, wherein the computer-executable instruction is executed by a processor to implement the above-described method. According to an exemplary implementation of the present disclosure, there is also provided a computer program product, which is tangibly stored on a non-transitory computer-readable medium and comprises computer-executable instructions that are executed by a processor to implement the method described above.

Aspects of the present disclosure are described herein with reference to flowchart illustrations and/or block diagrams of methods, apparatus, devices and computer program products implemented in accordance with the present disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, programmable data processing apparatus, and/or other devices to function in a particular manner, such that the computer-readable medium storing the instructions comprises an article of manufacture comprising instructions which implement various aspects of the functions/acts specified in the flowchart and/or block diagram block or blocks.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions which execute on the computer, other programmable data processing apparatus, or other devices implement the functions/acts specified in the flowchart and/or block diagram block or blocks.

The flowchart and block diagrams in the Figures illustrate the architecture, functionality, and operation of possible implementations of systems, methods and computer program products according to various implementations of the present disclosure. In this regard, each block in the flowchart or block diagrams may represent a module, segment, or portion of an instruction which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Having described implementations of the disclosure above, the foregoing description is exemplary, not exhaustive, and is not limited to the implementations disclosed. Many modifications and variations will be apparent to those of ordinary skill in the art without departing from the scope and spirit of the implementations described. The choice of terms used herein is intended to best explain the principles of the implementations, the practical application, or improvements to technologies in the marketplace, or to enable others of ordinary skill in the art to understand the implementations disclosed herein.

What is claimed is:

1. An interaction method, comprising:
displaying a setting interface for a user, wherein the setting interface displays, in a first region, a set of static representations corresponding to a set of avatars, and the set of avatars are generated based on obtained image of the user;
displaying, based on a selection of a target static representation in the set of static representations, in a second region of the setting interface, a target dynamic representation corresponding to the target static representation, wherein the target static representation and the target dynamic representation are associated with a target avatar; and
associating the target avatar to the user.

2. The method of claim 1, further comprising:
presenting at least one of the target static representation or the target dynamic representation on a page associated with the user.

3. The method of claim 1, further comprising:
receiving a sliding operation associated with the second region; and
in response to the sliding operation, switching a first background from a first background style to a second background style, wherein the first background is associated to a target region of at least one of the target static representation or the target dynamic representation.

4. The method of claim 3, wherein the first background style or the second background style indicates at least one of a background color or a background pattern displayed within the target region.

5. The method of claim 4, wherein the target region has a shape corresponding to a component of the target avatar, and the component is configured to display at least one of the target static representation or the target dynamic representation with the second background style applied.

6. The method of claim 3, further comprising:
in response to the sliding operation, switching a second background of the setting interface from a third background style to a fourth background style;
in response to a preview request, presenting an editing interface of a first content item, the first content item comprising: a third background corresponding to the fourth background style, and at least one of the target static representation or the target dynamic representation with the second background style applied; and
posting the first content item in response to a first posting request received in the editing interface.

7. The method of claim 1, further comprising:
in response to a second posting request received in the setting interface, posting a second content item associated with the target avatar.

8. The method of claim 1, wherein the target static representation comprises a target image frame of a plurality of image frames of the target dynamic representation.

9. The method of claim 1, wherein the set of avatars are generated through:
obtaining at least one reference image based on an operation of the user;
acquiring a visual model based on the at least one reference image;
generating, based on the visual model, a plurality of dynamic image contents corresponding to a plurality of actions; and
constructing the set of avatars based on the plurality of dynamic image contents.

10. The method of claim 9, wherein the image is generated based on the constructed set of avatars.

11. The method of claim 1, wherein the set of avatars comprise a plurality of avatars corresponding to a plurality of expressing states of the user.

12. The method of claim 11, wherein the expressing states comprise at least one of an action process or a static expression, and wherein:
a plurality of dynamic representations of the plurality of avatars correspond to different action processes of the user;
a plurality of static representations of the plurality of avatars correspond to different static expressions of the user.

13. The method of claim 11, further comprising:
obtaining reference information associated with the user;
determining, from the plurality of expressing states, a target expressing state that matches the reference information; and
associating an avatar corresponding to the target expressing state to the user.

14. The method of claim 1, further comprising:
determining, based on a type of the page, a style for the avatar presented on the page from the target static representation and the target dynamic representation.

15. The method of claim 1, further comprising:
generating a set of materials associated with the set of avatars; and
displaying the set of materials with a highlighted outline.

16. An electronic device, comprising:
at least one processor; and
at least one memory coupled to the at least one processor and storing instructions for execution by the at least one processor, wherein the instructions, when executed by the at least one processor, cause the electronic device to perform acts comprising:
displaying a setting interface for a user, wherein the setting interface displays, in a first region, a set of static representations corresponding to a set of avatars, and the set of avatars are generated based on obtained image of the user;
based on a selection of a target static representation in the set of static representations, displaying, in a second region of the setting interface, a target dynamic representation corresponding to the target static representation, wherein the target static representation and the target dynamic representation are associated with a target avatar; and
associating the target avatar to the user.

17. The electronic device of claim 16, wherein the acts further comprise:
presenting at least one of the target static representation or the target dynamic representation on a page associated with the user.

18. The electronic device of claim 16, wherein the acts further comprise:
receiving a sliding operation associated with the second region; and
in response to the sliding operation, switching a first background from the first background style to a second background style, wherein the first background is associated to a target region of at least one of the target static representation or the target dynamic representation.

19. The electronic device of claim 18, wherein the first background style or the second background style indicates at least one of a background color or a background pattern displayed within the target region.

20. A non-transitory computer readable storage medium, with a computer program stored thereon, wherein the computer program is executable by a processor to implement a method comprising:
displaying a setting interface for a user, wherein the setting interface displays, in a first region, a set of static representations corresponding to a set of avatars, and the set of avatars are generated based on obtained image of the user;
based on a selection of a target static representation in the set of static representations, displaying, in a second region of the setting interface, a target dynamic representation corresponding to the target static representation, wherein the target static representation and the target dynamic representation are associated with a target avatar; and
associating the target avatar to the user.
